(19) United States
(12) Patent Application Publication
(10) Pub. No.: US 2025/0066211 A1
(43) Pub. Date: Feb. 27, 2025

(54) METHOD OF PRODUCING, SEPARATING, AND PURIFYING METAL SULFIDES AND METAL PHOSPHATES

(71) Applicant: Solid Power Operating, Inc., Louisville, CO (US)

(72) Inventors: Brian E. Francisco, Arvada, CO (US); Samuel Oberwetter, Lafayette, CO (US); Hyungrak Kim, Lafayette, CO (US)

(21) Appl. No.: 18/811,600

(22) Filed: Aug. 21, 2024

Related U.S. Application Data
(60) Provisional application No. 63/533,747, filed on Aug. 21, 2023.
(60) Provisional application No. 63/534,568, filed on Aug. 24, 2023.

(51) Int. Cl. C01D 15/04; H01M 10/0562

(52) U.S. Cl. CPC C01D 15/04; H01M 10/0562; H01M 2300/008

(57) ABSTRACT

The present disclosure provides novel compositions of matter and a robust one-pot process to produce solid-state electrolytes, metal sulfides, and/or metal phosphates. The metal sulfides include argyrodite-type sulfide electrolyte, and the metal phosphates include lithium phosphate.

### CROSS-REFERENCE TO RELATED APPLICATIONS

This application is related to and claims priority under 35 U.S.C. § 119 (e) from U.S. Patent Application No. 63/533,747 filed Aug. 21, 2023, titled “Method of Producing, Separating, and Purifying Metal Sulfides and Metal Phosphates,” and from U.S. Patent Application No. 63/534,568 filed Aug. 24, 2023, titled “Method of Producing, Separating, and Purifying Metal Sulfides and Metal Phosphates,” both of which are hereby incorporated by reference in their entirety.

### TECHNICAL FIELD

This disclosure generally relates to a method of producing a solid electrolyte, including electrolytes having an argyrodite-type crystal structure. This disclosure also generally relates to a method for producing metal sulfides and/or metal phosphates.

### BACKGROUND

In recent years, our reliance on rechargeable batteries to power our phones, computers, and cars has deepened dramatically. Also, there are increasing demands for batteries to contain more power, to last longer, and to be more economical. To meet these growing demands, companies and research alike have focused on the solid-state rechargeable battery, specifically those that contain solid-state sulfide electrolytes and/or other solid-state electrolytes.

Solid-state sulfide electrolytes are known to be used in lithium-ion batteries. Various crystal structures of the sulfide solid electrolyte are known, and a stable crystal structure whose structure is hardly changed over a wide temperature range is suitable in terms of expanding the operating temperature range of the battery. As such a sulfide solid electrolyte, for example, a sulfide solid electrolyte having an argyrodite-type crystal structure have been developed. The present disclosure provides novel compositions of matter and a robust one-pot process to produce solid-state electrolytes, metal sulfides, and/or metal phosphates.

### SUMMARY

The present disclosure is directed to a method of producing, separating, and purifying metal sulfides and metal phosphates. The present disclosure further relates to a solid electrolyte, including electrolytes having an argyrodite-type crystal structure.

Aspects of the present disclosure relate to a method of preparing Li_{(6-w)}PS_{(5-w)}X_{(1+w)}. The method includes combining LiX, Na₂S, and P₂S₅ in a solvent to form a mixture; and isolating a composition comprising Li_{(6-w)}PS_{(5-w)}X_{(1+w)} from the mixture; wherein X is one or more of Cl, Br, or I; wherein w is between about −1 to about 1.

In some embodiments of the method, the solvent comprises a polar organic solvent. In some embodiments, the solvent comprises pyridine and a second solvent. In other embodiments, the second solvent comprises an alcohol. In some embodiments, the solvent comprises ethanol, pyridine, or a combination thereof.

In one embodiment of the method, the isolated composition is at least 75% by weight Li_{(6-w)}PS_{(5-w)}X_{(1+w)}. In one embodiment, the isolated composition is at least 85% by weight Li_{(6-w)}PS_{(5-w)}X_{(1+w)}. In another embodiment, the isolated composition is at least 90% by weight Li_{(6-w)}PS_{(5-w)}X_{(1+w)}. In another embodiment, the isolated composition is at least 95% by weight Li_{(6-w)}PS_{(5-w)}X_{(1+w)}. In another embodiment, the isolated composition is at least 96% by weight Li_{(6-w)}PS_{(5-w)}X_{(1+w)}. In yet another embodiment, the isolated composition is at least 97% by weight Li_{(6-w)}PS_{(5-w)}X_{(1+w)}.

Aspects of the present disclosure further relate to a composition comprising at least 85% by weight Li_{(6-w)}PS_{(5-w)}X_{(1+w)} and between 0.01% and 15.0% Li₃PO_{4·}, wherein X is F, Cl, or Br. In one embodiment, the composition comprises least 90% by weight Li_{(6-w)}PS_{(5-w)}X_{(1+w)} and between 0.01% and 10.0% Li₃PO₄. In one embodiment, the composition comprises least 95% by weight Li₆PS₅X and between 0.01% and 5.0% Li₃PO₄. In one embodiment, the composition comprises between 0.01% and 1.5% Li₃PO₄. In one embodiment, the composition comprises between 0.01% and 1.5% by weight P₂S₅. In another embodiment, the composition comprises between 0.01% and 1.5% by weight Li₂S. In another embodiment, the composition comprises between 0.01% and 1.5% by weight Li₃PS₄, Li₇PS₆, Li₄PS₄I, Li_{5.5}PS_{4.5}ClBr_{0.5}, or a combination thereof. In yet another embodiment, the composition comprises between 0.01% and 1.5% by weight P₂S₅, between 0.01% by weight Li₂S, and between 0.01% and 1.5% by weight Li₃PS₄, Li₇PS₆, Li₄PS₄I, Li_{5.5}PS_{4.5}ClBr_{0.5}, or a combination thereof wherein X is F, Cl, or Br.

Aspects of the present disclosure further relate to a method of preparing Li₃PO₄. The method includes combining LiX, Na₂S, and P₂S₅ in a solvent to form a mixture; and isolating a composition comprising Li₃PO₄ from the mixture; wherein X is Cl, Br, or I.

In some embodiments of the method, the solvent comprises a polar organic solvent. In some embodiments, the solvent comprises pyridine and a second solvent. In other embodiments, the second solvent comprises an alcohol. In some embodiments, the solvent comprises ethanol, pyridine, or a combination thereof.

In some embodiments of the method, the isolated composition is at least 50% by weight Li₃PO₄. In one embodiment, the isolated composition is at least 60% by weight Li₃PO₄. In another embodiment, the isolated composition is at least 75% by weight Li₃PO₄. In another embodiment, the isolated composition is at least 85% by weight Li₃PO₄. In another embodiment the isolated composition is at least 90% by weight Li₃PO₄. In another embodiment, the isolated composition is at least 95% by weight Li₃PO₄. In another embodiment, the isolated composition is at least 96% by weight Li₃PO₄. In yet another embodiment, the isolated composition is at least 97% by weight Li₃PO₄.

Aspects of the present disclosure further relate to a method of preparing Li₆PS₅X or Li₃PO₄. The method includes combining LiX, Na₂S, and P₂S₅ in a solvent to form a mixture and isolating a composition comprising Li_{(6-w)}PS_{(5-w)}X_{(1+w)}, Li₃PO₄, or a combination thereof from the mixture, wherein X is Cl, Br, or I.

Aspects of the present disclosure further relate to a method of preparing Li_{(6-w)}PS_{(5-w)}X_{(1+w)} or Li₃PO₄. The method includes combining LiCl and Na₂S in a first solvent to form mixture, isolating a Li₂S intermediate from the mixture, combining the Li₂S intermediate and P₂S₅ in a second solvent to form a second mixture; and isolating Li_{(6-w)}PS_{(5-w)}X_{(1+w)}, Li₃PO₄, or a combination thereof from the second mixture, wherein X is Cl, Br, or I.

Aspects of the present disclosure further relate to a method of producing lithium argyrodite or lithium phosphate. The method includes (a) reacting a first metal sulfide, a first alkali metal salt, and elemental sulfur in a first polar solvent to produce a first intermediate mixture and a second alkali metal salt precipitate; wherein the first intermediate mixture comprises a second metal sulfide, the first polar solvent, and the first alkali metal salt, (b) separating the second alkali metal salt precipitate and the first intermediate mixture, (c) adding phosphorous sulfide to the first intermediate mixture comprising the first alkali metal salt, the second metal sulfide and the first polar solvent forming a second intermediate mixture, wherein the phosphorous sulfide comprises solid phosphorous sulfide, a solution of phosphorous sulfide in a second polar solvent, or a mixture thereof, (d) removing the first and the second polar solvent from the second intermediate mixture to produce a dried second intermediate mixture; and (e) calcining the dried second intermediate mixture to remove residual first and second polar solvents and to produce a product mixture comprising lithium argyrodite, lithium phosphate, or a combination thereof. In some embodiments, the method is a one-pot synthesis. In some embodiments, the lithium phosphate comprises Li₃PO₄. In other embodiments, the lithium argyrodite formula comprises Li₆PS₅X, wherein X is Cl, Br, or I.

In some embodiments, the first alkali metal salt, elemental sulfur, and the first metal sulfide are separately dissolved in aliquots of the first polar solvent, which separate aliquots are then combined to form the first intermediate mixture.

In some embodiments, the phosphorous sulfide solution comprises about 5 wt % to about 20 wt % of P₂S₅.

In some embodiments, the amount of phosphorous sulfide added correlates with the amount of Li₃PO₄ formed.

In some embodiments, the removing the first and the second polar solvent comprises evaporating the first and second polar solvent to produce a powder.

In some embodiments, the evaporating comprises drying the powder to remove substantially all of the first and second polar solvent. In one embodiment, over 99% by weight of the first and second polar solvent from the powder is removed. In some embodiments, the removing of the first and the second polar solvent comprises spray drying, rotary drying, try drying, fluidized bed drying, vacuum drying, or a combination thereof.

In some embodiments, separating the second alkali metal salt from the first intermediate mixture comprises at least one of centrifuging, filtering, gravity settling, and cooling.

In some embodiments, the first metal sulfide comprises Na₂S, the first alkali metal salt comprises LiCl, the second metal sulfide comprises Li₂S, and the phosphorous sulfide comprises P₂S₅.

In some embodiments, the second alkali metal salt comprises NaCl and the second sulfide comprises Li₂S.

In some embodiments, the first polar solvent comprises at least one alcohol selected from the group consisting of methanol, ethanol, 1-propanol, 1-butanol, and mixtures thereof.

In some embodiments, the second polar solvent comprises pyridine, imidazole, and mixtures thereof.

In some embodiments, the second polar solvent is pyridine.

In some embodiments, removing the second alkali metal salt from the supernatant comprises at least one of centrifuging, filtering, gravity settling, and cooling.

In some embodiments, the first and second polar solvents are substantially anhydrous.

In some embodiments, the ratio of the solubility of the second sulfide to the solubility of the second alkali metal salt in the polar solvent is at least 90:10.

In some embodiments, the ratio of the solubility of the second sulfide to the solubility of the second alkali metal salt in the polar solvent is at least 97:3.

In some embodiments, the ratio of the solubility of the second sulfide to the solubility of the second alkali metal salt in the polar solvent is at least 99:1

In some embodiments, the ratio of the solubility of the second sulfide to the solubility of the second alkali metal salt in the polar solvent is at least 99.9:0.1.

In some embodiments, the first metal sulfide compound is selected from the group consisting of K₂S, Na₂S, (NH₄)₂S, and mixtures thereof.

In some embodiments, the second sulfide comprises Li₂S.

In some embodiments, the phosphorous sulfide is P₂S₅.

In some embodiments, the second sulfide comprises a purity of 95% or greater.

In some embodiments, the second sulfide has a mass loss of less than 10% when heated above 100° C.

In some embodiments, the second sulfide has a mass loss of less than 13% when heated above 340° C.

Aspects of the present disclosure further relate to a solid-state electrolyte comprising the lithium argyrodite produced by the method described herewith.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure may be understood by reference to the following detailed description taken in conjunction with the drawings briefly described below. It is noted that, for purposes of illustrative clarity, certain elements in the drawings may not be drawn to scale.

FIG. 1 is a schematic illustration of the one-pot synthesis according to the present disclosure.

FIG. 2 shows XRD patterns of the solid-state electrolyte obtained according to the present disclosure.

FIG. 3 shows XRD patterns of the solid-state electrolyte obtained according to the present disclosure.

FIG. 4 shows XRD patterns of solid-state electrolytes obtained according to the present disclosure.

FIG. 5 shows XRD pattern of the solid-state electrolyte obtained according to the present disclosure.

FIG. 6 shows XRD patterns of solid-state electrolytes obtained according to the present disclosure.

### DETAILED DESCRIPTION

In the following description, specific details are provided to impart a thorough understanding of the various embodiments of the disclosure. Upon having read and understood the specification, claims, and drawings hereof, those skilled in the art will understand that some embodiments may be practiced without hewing to some of the specific details set forth herein. Moreover, to avoid obscuring the disclosure, some well-known methods, processes, devices, and systems utilized in the various embodiments described herein are not disclosed in detail.

### Method of Synthesizing a Solid-State Electrolyte Composition

The current disclosure provides a method of synthesizing a solid-state electrolyte composition including an argyrodite-type sulfide electrolyte, lithium phosphate, or a combination thereof. The argyrodite-type sulfide electrolyte may be prepared by combining a metal halide, a metal sulfide, and a phosphorous sulfide in a first solvent to form a mixture and isolating the solid-state electrolyte composition from the mixture. The method may be a one-pot synthesis. The end-result may comprise a solid-state electrolyte composition including an argyrodite-type sulfide electrolyte, lithium phosphate, or a combination thereof.

One general reaction scheme for making a sulfide solid electrolyte is provided below. The quantity of specific reactants may be adjusted to satisfy a desired product composition.
1. Metathesis reaction in solvent

M1X₍ₛₒₗ₎+M2₂Sₓ₍ₛₒₗ₎→M2X₍ₛ₎+M1₂Sₓ₍ₛₒₗ₎+M1X₍ₛₒₗ₎
2. Filter to remove insoluble compounds

M1₂Sₓ₍ₛₒₗ₎+M1X₍ₛₒₗ₎+M2X₍ₛ₎→M1₂Sₓ₍ₛₒₗ₎+M1X₍ₛₒₗ₎
3. Add phosphorous sulfide and remove solvent

M1₂Sₓ₍ₛₒₗ₎+P_{y}S_{z}+M1X₍ₛₒₗ₎→M1₂Sₓ₍ₛ₎+P_{y}S_{z(s)}+M1X₍ₛ₎+M1₂P_{y}S_{z}X₍ₛ₎
4. Calcinate to form a product mixture including sulfide electrolyte and remove residual solvent

M1₂Sₓ₍ₛ₎+P_{y}S_{z(s)}+M1X₍ₛ₎→M1₂P_{y}S_{z}X₍ₛ₎

Another general scheme for making a sulfide solid electrolyte is provided below. The quantity of specific reactants may be adjusted to satisfy a desired product composition.
5. Dissolution of one or more alkali metal materials

M1₂Sₓ₍ₛ₎+M1X₍ₛ₎→M1₂Sₓ₍ₛₒₗ₎+M1X₍ₛₒₗ₎
6. Add phosphorous sulfide and remove solvent

M1₂Sₓ₍ₛₒₗ₎+P_{y}S_{z}+M1_{X(sol)}→M1₂Sₓ₍ₛ₎+P_{y}S_{z(s)}+M1X₍ₛ₎+M1₂P_{y}S_{z}X₍ₛ₎
7. Calcinate to form a product mixture including metal argyrodite-type sulfide electrolyte and remove residual solvent

M1₂Sₓ₍ₛ₎+P_{y}S_{z(s)}+M1X₍ₛ₎→M1₂P_{y}S_{z}X₍ₛ₎

In another general scheme for making a sulfide solid electrolyte is provided below. The quantity of specific reactants may be adjusted to satisfy a desired product composition.
8. Dissolution of one or more alkali metal materials

M1₂Sₓ₍ₛ₎+M1X₍ₛ₎→M1₂Sₓ₍ₛₒₗ₎+M1X₍ₛₒₗ₎
9. Add phosphorous sulfide and remove solvent

M1₂Sₓ₍ₛₒₗ₎+P_{y}S_{z}+QS+M1X₍ₛₒₗ₎→M1₂Sₓ₍ₛ₎+P_{y}S_{z+Q(s)}+M1X₍ₛ₎+M1₂P_{y}S_{z}X₍ₛ₎
10. Calcinate to form a product mixture including metal argyrodite-type sulfide electrolyte and remove residual solvent

M1₂Sₓ₍ₛ₎+P_{y}S_{z+Q(s)}+M1X₍ₛ₎→M1₂P_{y}S_{z+Q}X₍ₛ₎

In a further general scheme for making a sulfide solid electrolyte is provided below. The quantity of specific reactants may be adjusted to satisfy a desired product composition.
11. Dissolution of one or more alkali metal materials

M1₂Sₓ₍ₛ₎+QS+M1X₍ₛ₎→M1₂S_{x+Q(sol)}+M1X₍ₛₒₗ₎
12. Add phosphorous sulfide and remove solvent

M1₂S_{x+Q(sol)}+P_{y}S_{z}+M1X₍ₛₒₗ₎→M1₂S_{x+Q(s)}+P_{y}S_{z(s)}+M1X₍ₛ₎+M1₂P_{y}S_{z+Q}X₍ₛ₎
13. Calcinate to form a product mixture including metal argyrodite-type sulfide electrolyte and remove residual solvent

M1₂S_{x+Q(s)}+P_{y}S_{z(s)}+M1X₍ₛ₎→M1₂P_{y}S_{z+Q}X₍ₛ₎

In one embodiment, the above reaction (and other reactions described herein) may be performed as a one-pot synthesis. The development of one-pot syntheses, in which at least two sequential transformations are performed in a single reaction flask, may provide additional efficiency. For example, a one-pot process may save resources with the reduction of the produced waste compared with the traditional ‘stop-and-go’ approaches. In the ‘stop-and-go’ approach, after each chemical transformation the process may be stopped previous to the subsequent reaction pathway in order to eliminate the reaction media and/or for the purification and isolation of the reaction intermediate. In this context, at industrial scale and in other contexts, a one-pot synthesis approach may be the best solution to reduce time, costs, resources and waste generation, since these processes may avoid the purification of the intermediates between individual steps, where major efforts are invested. Moreover, by reducing the number of synthetic steps and avoiding the purification processes, it may be possible to reduce the loss of material and thus to increase the overall yield of the reaction.

In the above reactions, M1 and M2 are an alkali metal or an alkaline earth metal and X is a halide. Non-limiting examples of alkali metals include Li, Na, K, Rb, or Cs. Non-limiting examples of alkaline earth metals include Be, Mg, Ca, Sr, or Ba. In the above reactions, X is F, Cl, or Br. Examples of metal salts include but are not limited to LiCl, LiBr, Lil, NaCl, NaBr, NaI, KCl, KBr, Kl, MgCl₂, MgBr₂, Mgl₂, MgS, CaCl₂, CaBr₂, CaI₂, CaS and combinations thereof.

In the reactions above, x is a number greater than about 1 and less than about 8. In some embodiments, x may be about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, about 7.0, about 7.1, about 7.2, about 7.3, about 7.4, about 7.5, about 7.6, about 7.7, about 7.8, about 7.9, or about 8.0.

In the reactions above, y is a number greater than about 1 and less than about 4. In some embodiments, y may be about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, or about 4.0.

In the reactions above, z is a number greater than about 1 and less than about 40. In some embodiments, z may be about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, about 7.0, about 7.1, about 7.2, about 7.3, about 7.4, about 7.5, about 7.6, about 7.7, about 7.8, about 7.9, about 8.0, about 8.1, about 8.2, about 8.3, about 8.4, about 8.5, about 8.6, about 8.7, about 8.8, about 8.9, about 9.0, about 9.1, about 9.2, about 9.3, about 9.4, about 9.5, about 9.6, about 9.7, about 9.8, about 9.9, or about 10.0. In other embodiments, z may be about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, or about 40.

In the reactions above, Q is a number greater than about 1 and less than about 40. In some embodiments, z may be about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, about 7.0, about 7.1, about 7.2, about 7.3, about 7.4, about 7.5, about 7.6, about 7.7, about 7.8, about 7.9, about 8.0, about 8.1, about 8.2, about 8.3, about 8.4, about 8.5, about 8.6, about 8.7, about 8.8, about 8.9, about 9.0, about 9.1, about 9.2, about 9.3, about 9.4, about 9.5, about 9.6, about 9.7, about 9.8, about 9.9, or about 10.0. In other embodiments, z may be about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, or about 40.

The first metal halide and the first metal sulfide may be dissolved in a suitable solvent. The solvent may be a polar organic solvent. The solvent may be a polar protic organic solvent (e.g., an alcohol). Examples of suitable polar protic organic solvents may comprise but are not limited to any one of methanol, ethanol, propanol, butanol, or combinations thereof. The solvents may be substantially anhydrous.

The metathesis reaction may include mixing a first metal halide, a first metal sulfide, and optionally elemental sulfur in a polar solvent for about 1 minute to about 4 hours at a suitable temperature to form an intermediate mixture including a second metal halide and a second metal sulfide. The mixture may be mixed for about 1 minute, about 5 minutes, about 10 minutes, about 20 minutes, about 30 minutes, about 1 hour, about 1.5 hours, about 2 hours, about 2.5 hours, about 3 hours, about 3.5 hours, or about 4 hours to form an intermediate mixture. In one embodiment, the suitable temperature may be room temperature.

After the metathesis reaction, any insoluble compounds may be removed from the intermediate mixture using appropriate techniques. Suitable techniques include but are not limited to centrifugation, filtration, gravity settling, or cooling. In one embodiment, the intermediate mixture may be centrifuged to remove any insoluble metal halide. In some embodiments, the second metal halide may be insoluble in the polar solvent.

Phosphorous sulfide may be added to the intermediate mixture. Phosphorous sulfides added to the intermediate mixture include but are not limited to P₄S₃, P₄S₄, P₄S₅, P₄S₆, P₄S₇, P₄S₈, P₄S₉ or P₄S₁₀ (P₂S₅), P₄S₁₁, P₄S₁₂, P₄S₁₃, P₄S₁₄ or P₄S₂₀, and the like. Phosphorous sulfide added to the reaction may be solid phosphorous sulfide or a phosphorous sulfide solution in a solvent. The solvent may be an aprotic polar solvent. Examples of aprotic polar solvents include but are not limited to pyridine, imidazole, chloroform, diethyl ether, ethyl acetate, methylene chloride, or combinations thereof. The solvent may be a polar protic solvent. Examples of protic polar solvent include but is not limited to ethanol. The solvent may be the same or different from the solvent used in the metathesis step. The solvent may also be a slightly protic polar solvent. Examples of slightly protic polar solvents include but are not limited to formamides such as n-methylformamide or dimethyl formamide, acetamide, n-methylacetamide, or combinations thereof.

The solution may be prepared at a molar ratio of solvent to phosphorous sulfide of about 2:1 to about 10:1. For example, the ratio of solvent to phosphorous sulfide may be about 2.5:1, about 3:1, about 3.5:1, about 4:1, about 4.5:1, about 5:1, about 5.5:1, about 6:1, about 6.5:1, about 7:1, about 7.5:1, about 8:1, about 8.5:1, about 9:1, about 9.5:1, or about 10:1.

The ratio of the protic solvent used in the metathesis step and the aprotic solvent used to prepare a solution of phosphorous sulfide may be used to control the percent of Li₃PO₄ formed after the addition of the phosphorous sulfide. The ratio of the protic solvent:aprotic solvent may range from about 1:0 to about 10:1. For example, the ratio may be about 1:0, about 2:1, about 4:1, about 5:1, about 6:1, about 7:1, about 8:1, about 9:1, or about 10:1. In some embodiments, the ratio of the protic solvent:aprotic solvent may be 4:1.

Phosphorous sulfide may be added at about 0 wt % excess to about 20 wt % excess relative to the second metal sulfide. For example, phosphorous sulfide may be added at about 0.5 wt % excess, about 1.0 wt % excess, about 1.5 wt % excess, about 2.0 wt % excess, about 2.5 wt % excess, about 3.0 wt % excess, about 3.5 wt % excess, about 4.0 wt % excess, about 4.5 wt % excess, about 5.0 wt % excess, about 5.5 wt % excess, about 6.0 wt % excess, about 6.5 wt % excess, about 7.0 wt % excess, about 7.5 wt % excess, about 8.0 wt % excess, about 8.5 wt % excess, about 9.0 wt % excess, about 9.5 wt % excess, about 10.0 wt % excess, about 10.5 wt % excess, 11.0 wt % excess, about 11.5 wt % excess, 12.0 wt % excess, about 12.5 wt % excess, 13.0 wt % excess, about 13.5 wt % excess, 14.0 wt % excess, about 14.5 wt % excess, about 15.0 wt % excess, about 15.5 wt % excess, about 16.0 wt % excess, about 16.5 wt % excess, about 17.0 wt % excess, about 17.5 wt % excess, about 18.0 wt % excess, about 18.5 wt % excess, about 19.0 wt % excess, about 19.5 wt % excess, to about 20.0 wt % excess.

After the addition of phosphorous sulfide, bulk solvents may be removed from the intermediate mixture by spray drying, rotary drying, tray drying, fluidized bed drying, vacuum drying, or a combination thereof. In one embodiment, bulk solvents may be removed by placing the mixture under vacuum for about 1 hour to about 4 hours at a temperature ranging from about 60° C. to about 160° C. The intermediate mixture may be under vacuum for about 1.5 hours, about 2 hours, about 2.5 hours, about 3 hours, about 3.5 hours, or about 4 hours. The temperature may be about 60° C., about 61° C., about 62° C., about 63° C., about 64° C., about 65° C., about 66° C., about 67° C., about 68° C., about 69° C., about 70° C., about 71° C., about 72° C., about 73° C., about 74° C., about 75° C., about 76° C., about 77° C., about 78° C., about 79° C., about 80° C., about 81° C., about 82° C., about 83° C., about 84° C., about 85° C., about 86° C., about 87° C., about 88° C., about 89° C., about 90° C., about 91° C., about 92° C., about 93° C., about 94° C., about 95° C., about 96° C., about 97° C., about 98° C., about 99° C., about 100° C., about 101° C., about 102° C., about 103° C., about 104° C., about 105° C., about 106° C., about 107° C., about 108° C., about 109° C., about 110° C., about 110° C., about 111° C., about 112° C., about 113° C., about 114° C., about 115° C., about 116° C., about 117° C., about 118° C., about 119° C., about 120° C., about 121° C., about 122° C., about 123° C., about 124° C., about 125° C., about 126° C., about 127° C., about 128° C., about 129° C., about 130° C., about 131° C., about 132° C., about 133° C., about 134° C., about 135° C., about 136° C., about 137° C., about 138° C., about 139° C., or about 140° C.

After removing bulk solvent from the intermediate mixture, the mixture may be calcinated to remove residual solvent and crystalize the intermediate products to form a product mixture.

In some embodiments, the product mixture includes Li₃PO₄. The product mixture may include lithium phosphate at about 50 wt % or greater. The percent of lithium phosphate may be about 50 wt %, about 51 wt %, about 52 wt %, about 53 wt %, about 54 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt %, about 66 wt %, about 67 wt %, about 68 wt %, about 69 wt %, about 70 wt %, about 71 wt %, about 72 wt %, about 73 wt %, about 74 wt %, 75 wt %, about 76 wt %, about 77 wt %, about 78 wt %, about 79 wt %, about 80 wt %, about 81 wt %, about 82 wt %, about 83 wt %, about 84 wt %, about 85 wt %, about 86 wt %, about 87 wt %, about 88 wt %, about 89 wt %, about 90 wt %, about 91 wt %, about 92 wt %, about 93 wt %, about 94 wt %, about 95 wt %, about 96 wt %, about 97 wt %, about 98 wt %, about 99 wt %, or about 100 wt %.

In some embodiments, the product mixture includes Li₃PO₄ and a solid-state electrolyte composition. The product mixture may include lithium phosphate at about 50 wt % or less. The percent of lithium phosphate may be about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, or about 50 wt %.

In some embodiments, the product mixture includes a solid-state electrolyte composition. In one embodiment, the solid-state electrolyte composition may include an argyrodite-type sulfide electrolyte of formula M12P_{y}S_{z}X, where M1, X, y, and z are as described above. In one embodiment, the argyrodite-type sulfide electrolyte may be lithium argyrodite (Li₆PS₅Cl). In other embodiments, the argyrodite-type sulfide electrolyte may satisfy the formula Li_{6-w}PS_{5-w}Cl_{1+w}, where w is any number from about −1 to about 1. In a further embodiment, the argyrodite-type electrolyte may satisfy the Li⁺_{(12-n-w)}Bⁿ⁺_{6-w}Y^{-x}_{w}, wherein Bⁿ⁺ is P, As, Ge, Ga, Sb, Si, Sn, Al, In, Ti, V, Nb, or Ta; X²⁻ is S, Se, or Te; Y⁻ is Cl, Br, I, F, BH₄, BF₄, CN, OCN, SCN, or N₃; wherein x is any number from about 0 to about 1; wherein n is any number from about 3 to about 5; and wherein w is any number from about 0 to about 2.

In some embodiments, the product mixture includes a solid-state electrolyte composition of formula Li_{(A)}M1_{(α)}M2_{(β)}P_{(B)}S_{(C)}X_{(D}, where M1 and M2 are an alkali metal such as Li, Na, K, Rb, or Cs, or an alkaline earth such as Be, Mg, Ca, Sr, or Ba, where X is a halogen such as F, Cl, Br, or 1, 2≤A≤9, 0≤a≤2, 0≤β≤2, 1≤B≤3, 2≤C≤12, and 0≤D≤3. For example, A may be from about 2 to about 9, about 3 to about 8, about 4 to about 7, or about 5 to about 6. For example, B may be from about 1 to about 3, about 1.5 to about 2.5, or from about 2.0 to about 2.25. For example, α may be from about 0 to about 3, about 1 to about 2, or from about 1.5 to about 1.75. For example, β may be from about 0 to about 3, about 1 to about 2, or from about 1.5 to about 1.75. For example, C may be from about 2 to about 12, about 3 to about 11, about 4 to about 10, about 5 to about 9, about 6 to about 8, or about 6.5 to about 7.5. For example, D may be from about 0 to about 3, about 0.5 to about 2.5, about 1 to about 2.0, or from about 1.5 to about 1.75.

In some embodiments, the product mixture may include Li₃PS₄, Li₇PS₆, Li₇P₃S₁₁, Li₇P₂S₈X, Li₄PS₄X, Li₉P₃S₁₁X, Li₃M1_{α}M2_{β}PS₄, Li₃M1_{α}M2_{β}PS_{(4+β)}X_{(α)}, Li₇M1_{α}M2_{β}PS₆, Li₇M1_{α}M2_{β}P₃S₁₁X_{(α+β)}, Li₄M1_{α}M2_{β}PS₄X_{(1+α+β)}, Li₆M1_{α}M2_{β}PS₅X_{(1+α+β)}, or Li₇M1_{α}M2_{β}P₂S₈X_{(1+α+β)}.

In some embodiments, the product mixture includes a solid-state electrolyte composition of formula Li_{(A)}M1_{(α)}M2_{(β)}P_{(B)}S_{(C)}O_{(E)}X_{(D)} where M1, M2, and X are described above, 2≤A≤9, 0≤α≤2, 0≤β≤2, 1≤B≤3, 2≤C≤12, 0≤D≤3, and 0≤E≤11. In some embodiments, the product mixture may include Li₃PO₄, Li₃PS₃O, Li₇PS_{(6-E)}O_{(E)}, Li₇P₃S₇O₍₄₎, Li₇P₂S₆O₂X, Li₄PS_{(4-E)}O_{(E)}X, Li₉P₃S₁₁X, Li₃M1_{α}M2_{β}PS₃O, Li₃M1_{α}M2_{β}PS_{(4+β)}X_{(α)}, Li₇M1_{α}M2_{β}P S_{(6-E)}O_{(E)}, Li₇M1_{α}M2_{β}P₃S₅O₃X_{(α+β)}, Li₄M1_{α}M2_{β}PS₄X_{(1+α+β)}, Li₆M1_{α}M2_{β}PS₅X_{(1+α+β)}, or Li₇M1_{α}M2_{β}P₂S₈X_{(1+α+β)}.

In some embodiment, the first step of the synthesis includes forming a reaction mixture of a lithium chloride solution in ethanol, a sodium sulfide solution in ethanol, and elemental sulfur. The reaction mixture may be mixed for 2 hours to form an intermediate mixture of lithium sulfide and sodium chloride. In another embodiment, sodium chloride may be removed from the intermediate mixture by centrifugation. In some embodiments, the phosphorous sulfide may be added to the intermediate mixture. In one embodiment, the phosphorous sulfide may be phosphorous (V) sulfide (P₂S₅). In another embodiment, the phosphorous (V) sulfide may be solid powder. In yet another embodiment, the phosphorous (V) sulfide may be a solution of phosphorous (V) sulfide in pyridine. The solution of the phosphorous (V) sulfide in pyridine may result in the formation of a P₂S₅·2pyridine complex. This complex may protect phosphorous (V) sulfide from ethanol. In some embodiments, the amount of pyridine and phosphorous sulfide added may lead to the formation Li₃PO₄ as the primary product.

In some embodiments, ethanol and pyridine may be removed from the intermediate mixture by placing the intermediate mixture under vacuum at about 140° C. After removing bulk solvent from the intermediate mixture, the intermediate mixture may be calcinated to remove residual solvents and crystallize the intermediates to form a product mixture.

In some embodiments, the product mixture includes argyrodite-type sulfide electrolyte material. In some embodiments, the argyrodite-type sulfide electrolyte may be lithium argyrodite (Li₆PS₅Cl).

The general reaction is:
1. First metathesis reaction in solvent

3LiCl₍ₛₒₗ₎+Na₂S₍ₛₒₗ₎→2NaCl₍ₛ₎+Li₂S₍ₛₒₗ₎+LiCl₍ₛₒₗ₎
2. Centrifuge to remove insoluble byproduct

2NaCl₍ₛ₎+Li₂S₍ₛₒₗ₎+LiCl₍ₛₒₗ₎→Li₂S₍ₛₒₗ₎+LiCl₍ₛₒₗ₎
3. Add phosphorous sulfide and remove solvent

Li₂S₍ₛₒₗ₎+P₂S₅₍ₛₒₗ₎+LiCl₍ₛₒₗ₎→Li₂S₍ₛ₎+LiCl₍ₛ₎+P₂S₅₍ₛ₎
4. Calcinate to remove residual solvent and form a product mixture including argyrodite-type sulfide electrolyte.

3/2Li₂S₍ₛ₎+½P₂S₅₍ₛ₎+LiCl₍ₛ₎→Li₃PS₄₍ₛ₎+LiCl₍ₛ₎

Li₂S₍ₛ₎+LiCl₍ₛ₎+Li₃PS₄₍ₛ₎→Li₆PS₅Cl₍ₛ₎

In one embodiment, the above reaction (and other reactions described herein) may be performed as a one-pot synthesis. The development of one-pot syntheses, in which at least two sequential transformations are performed in a single reaction flask, may provide additional efficiency. For example, a one-pot process may save resources with the reduction of the produced waste compared with the traditional ‘stop-and-go’ approaches. In the ‘stop-and-go’ approach, after each chemical transformation the process may be stopped previous to the subsequent reaction pathway in order to eliminate the reaction media and/or for the purification and isolation of the reaction intermediate. In this context, at industrial scale and in other contexts, a one-pot synthesis approach may be the best solution to reduce time, costs, resources and waste generation, since these processes may avoid the purification of the intermediates between individual steps, where major efforts are invested. Moreover, by reducing the number of synthetic steps and avoiding the purification processes, it may possible to reduce the loss of material and thus to increase the overall yield of the reaction.

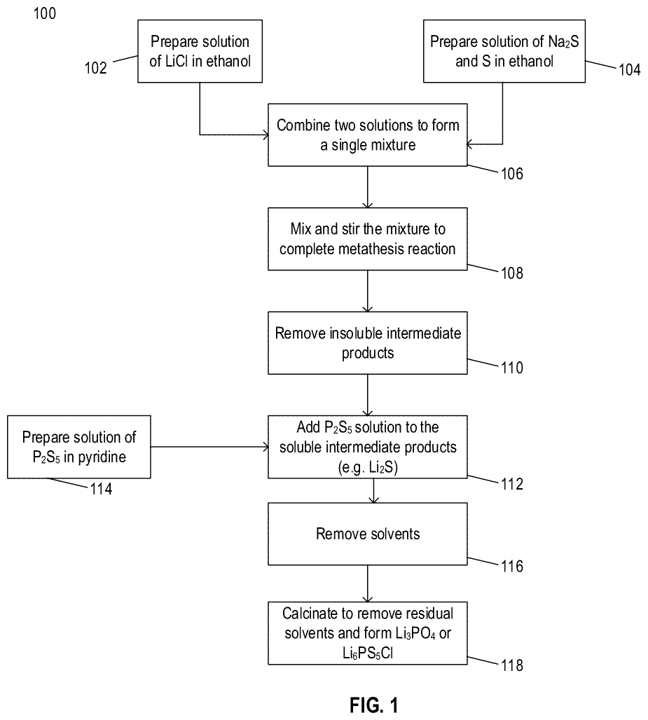

FIG. 1 shows a schematic illustration of the one-pot synthesis 100 of the present disclosure. The first step of the synthesis includes forming a reaction mixture 106 of a lithium chloride solution in ethanol 102 and a sodium sulfide and elemental sulfur solution in ethanol 104. The reaction mixture may be mixed for 2 hours to form an intermediate mixture of lithium sulfide and sodium chloride 108. The insoluble sodium chloride may be removed from the intermediate mixture by centrifugation 110. As shown in 112, a solution of phosphorous (V) sulfide in pyridine 114 may be added to the intermediate mixture. Next solvents such as ethanol and pyridine may be removed from the intermediate mixture 116. The dry intermediate mixture may be calcinated resulting in the formation of metal sulfides and/or metal phosphates including Li₆PS₅Cl and/or Li₃PO₄.

### Solid-State Electrolyte Composition

The solid-state electrolyte composition may include an argyrodite-type sulfide electrolyte. The argyrodite-type sulfide may be lithium argyrodite at about 75 wt % or greater. The percent of lithium argyrodite may be about 75 wt %, about 76 wt %, about 77 wt %, about 78 wt %, about 79 wt %, about 80 wt %, about 81 wt %, about 82 wt %, about 83 wt %, about 84 wt %, about 85 wt %, about 86 wt %, about 87 wt %, about 88 wt %, about 89 wt %, about 90 wt %, about 91 wt %, about 92 wt %, about 93 wt %, about 94 wt %, about 95 wt %, about 96 wt %, about 97 wt %, about 98 wt %, about 99 wt %, or about 100 wt %.

The solid-state electrolyte composition may include at least about 80 wt % of the lithium argyrodite and between about 0.01 wt % to about 20 wt % of Li₃PO₄. The solid-state electrolyte composition may include lithium argyrodite at least at about 80 wt %, about 81 wt %, about 82 wt %, about 83 wt %, about 84 wt %, about 85 wt %, about 86 wt %, about 87 wt %, about 88 wt %, about 89 wt %, about 90 wt %, about 91 wt %, about 92 wt %, about 93 wt %, about 94 wt %, about 95 wt %, about 96 wt %, about 97 wt %, about 98 wt %, about 99 wt %, or about 100 wt %.

The solid-state electrolyte composition may include between about 0.01 wt % to about 20 wt % of Li₃PO₄. The solid-state electrolyte composition may include Li₃PO₄ at about 0.02 wt %, about 0.05 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, or about 20 wt %.

The solid-state electrolyte composition may include between about 0.01 wt % to about 2.0 wt % of P₂S₅. The amount of P₂S₅ may be about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, 1.1 wt %, about 1.2 wt %, about 1.3 wt %, about 1.4 wt %, about 1.5 wt %, about 1.6 wt %, about 1.7 wt %, about 1.8 wt %, about 1.9 wt %, or about 2.0 wt %.

The solid-state electrolyte composition may include between about 0.01 wt % to about 2.0 wt % of Li₂S. The amount of Li₂S may be about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, or about 2.0 wt %.

The solid-state electrolyte composition may include between about 0.01 wt % to about 10.0 wt % of LiCl. The amount of LiCl may be about 0.01 wt %, about 0.02 wt %, 0.03 wt %, 0.04 wt %, 0.05 wt %, 0.06 wt %, 0.07 wt %, 0.08 wt %, 0.09 wt %, 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2.0 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3.0 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4.0 wt %, about 4.1 wt %, about 4.2 wt %, about 4.3 wt %, about 4.4 wt %, about 4.5 wt %, about 4.6 wt %, about 4.7 wt %, about 4.8 wt %, about 4.9 wt %, about 5.0 wt %, about 5.1 wt %, about 5.2 wt %, about 5.3 wt %, about 5.4 wt %, about 5.5 wt %, about 5.6 wt %, about 5.7 wt %, about 5.8 wt %, about 5.9 wt %, about 6.0 wt %, about 6.1 wt %, about 6.2 wt %, about 6.3 wt %, about 6.4 wt %, about 6.5 wt %, about 6.6 wt %, about 6.7 wt %, about 6.8 wt %, about 6.9 wt %, about 7.0 wt %, about 7.1 wt %, about 7.2 wt %, about 7.3 wt %, about 7.4 wt %, about 7.5 wt %, about 7.6 wt %, about 7.7 wt %, about 7.8 wt %, about 7.9 wt %, about 8.0 wt %, about 8.1 wt %, about 8.2 wt %, about 8.3 wt %, about 8.4 wt %, about 8.5 wt %, about 8.6 wt %, about 8.7 wt %, about 8.8 wt %, about 8.9 wt %, about 9.0 wt %, about 9.1 wt %, about 9.2 wt %, about 9.3 wt %, about 9.4 wt %, about 9.5 wt %, about 9.6 wt %, about 9.7 wt %, about 9.8 wt %, about 9.9 wt %, or about 10.0 wt %.

The solid-state electrolyte composition may include between about 0.01 wt % to about 10.0 wt % of Li₃PS₄, Li₇PS₆, Li₄PS₄I, Li_{5.5}PS_{4.5}ClBr_{0.5}, or a combination thereof. The amount of Li₃PS₄, Li₇PS₆, Li₄PS₄I, Li_{5.5}PS_{4.5}ClBr_{0.5}, or a combination thereof may be about 0.01 wt %, about 0.02 wt %, 0.03 wt %, 0.04 wt %, 0.05 wt %, 0.06 wt %, 0.07 wt %, 0.08 wt %, 0.09 wt %, 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2.0 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3.0 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4.0 wt %, about 4.1 wt %, about 4.2 wt %, about 4.3 wt %, about 4.4 wt %, about 4.5 wt %, about 4.6 wt %, about 4.7 wt %, about 4.8 wt %, about 4.9 wt %, about 5.0 wt %, about 5.1 wt %, about 5.2 wt %, about 5.3 wt %, about 5.4 wt %, about 5.5 wt %, about 5.6 wt %, about 5.7 wt %, about 5.8 wt %, about 5.9 wt %, about 6.0 wt %, about 6.1 wt %, about 6.2 wt %, about 6.3 wt %, about 6.4 wt %, about 6.5 wt %, about 6.6 wt %, about 6.7 wt %, about 6.8 wt %, about 6.9 wt %, about 7.0 wt %, about 7.1 wt %, about 7.2 wt %, about 7.3 wt %, about 7.4 wt %, about 7.5 wt %, about 7.6 wt %, about 7.7 wt %, about 7.8 wt %, about 7.9 wt %, about 8.0 wt %, about 8.1 wt %, about 8.2 wt %, about 8.3 wt %, about 8.4 wt %, about 8.5 wt %, about 8.6 wt %, about 8.7 wt %, about 8.8 wt %, about 8.9 wt %, about 9.0 wt %, about 9.1 wt %, about 9.2 wt %, about 9.3 wt %, about 9.4 wt %, about 9.5 wt %, about 9.6 wt %, about 9.7 wt %, about 9.8 wt %, about 9.9 wt %, or about 10.0 wt %.

In one embodiment, the solid-state electrolyte composition includes between 0.01% and 1.5% by weight P₂S₅, between 0.01% by weight Li₂S, and between 0.01% and 1.5% by weight Li₃PS₄, Li₇PS₆, Li₄PS₄I, Li_{5.5}PS_{4.5}ClBr_{0.5}, or a combination thereof wherein X is F, Cl, or Br.

The solid-state electrolyte may have an ionic conductivity of between about 0.1 mS/cm to about 8.0 mS/cm. The ionic conductivity may be about 0.1 mS/cm, about 0.2 mS/cm, about 0.3 mS/cm, about 0.4 mS/cm, about 0.5 mS/cm, about 0.6 mS/cm, about 0.7 mS/cm, about 0.8 mS/cm, about 0.9 mS/cm, about 1.0 mS/cm, about 1.1 mS/cm, about 1.2 mS/cm, about 1.3 mS/cm, about 1.4 mS/cm, about 1.5 mS/cm, about 1.6 mS/cm, about 1.7 mS/cm, about 1.8 mS/cm, about 1.9 mS/cm, about 2.0 mS/cm, about 2.1 mS/cm, about 2.2 mS/cm, about 2.3 mS/cm, about 2.4 mS/cm, about 2.5 mS/cm, about 2.6 mS/cm, about 2.7 mS/cm, about 2.8 mS/cm, about 2.9 mS/cm, about 3.0 mS/cm, about 3.1 mS/cm, about 3.2 mS/cm, about 3.3 mS/cm, about 3.4 mS/cm, about 3.5 mS/cm, about 3.6 mS/cm, about 3.7 mS/cm, about 3.8 mS/cm, about 3.9 mS/cm, about 4.0 mS/cm, about 4.1 mS/cm, about 4.2 mS/cm, about 4.3 mS/cm, about 4.4 mS/cm, about 4.5 mS/cm, about 4.6 mS/cm, about 4.7 mS/cm, about 4.8 mS/cm, about 4.9 mS/cm, about 5.0 mS/cm, about 5.1 mS/cm, about 5.2 mS/cm, about 5.3 mS/cm, about 5.4 mS/cm, about 5.5 mS/cm, about 5.6 mS/cm, about 5.7 mS/cm, about 5.8 mS/cm, about 5.9 mS/cm, about 6.0 mS/cm, about 6.1 mS/cm, about 6.2 mS/cm, about 6.3 mS/cm, about 6.4 mS/cm, about 6.5 mS/cm, about 6.6 mS/cm, about 6.7 mS/cm, about 6.8 mS/cm, about 6.9 mS/cm, about 7.0 mS/cm, about 7.1 mS/cm, about 7.2 mS/cm, about 7.3 mS/cm, about 7.4 mS/cm, about 7.5 mS/cm, about 7.6 mS/cm, about 7.7 mS/cm, about 7.8 mS/cm, about 7.9 mS/cm, or about 8.0 mS/cm. In one embodiment, the ionic conductivity of the solid-state electrolyte is 1.42 mS/cm.

Unless defined otherwise, all technical and scientific terms used herein have the same meaning as commonly understood by those of ordinary skill in the art to which the disclosure belongs. Although any methods and materials similar or equivalent to those described herein can be used in the practice or testing of the subject matter of the present disclosure, preferred methods and materials are described. For the purposes of the present disclosure, the following terms are defined below.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

The term “about” will be understood by persons of ordinary skill in the art and will vary to some extent on the context in which it is used. As used herein when referring to a measurable value such as an amount, a temporal duration, and the like, the term “about” is meant to encompass variations of ±10%, including ±5%, ±1%, and ±0.1% from the specified value, as such variations are appropriate to perform the disclosed methods.

In this disclosure, “comprises,” “comprising,” “containing,” and “having” and the like can have the meaning ascribed to them in U.S. Patent Law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. In this specification when using an open ended term, like “comprising” or “including,” it is understood that direct support should be afforded also to “consisting essentially of” language as well as “consisting of” language as if stated explicitly and vice versa.

The disclosure will now be illustrated with working examples, and which are intended to illustrate the disclosure and not intended to restrict any limitations on the scope of the present disclosure. Unless defined otherwise, all technical and scientific terms used herein have the same meaning as commonly understood to one of ordinary skill in the art to which this disclosure belongs.

### EXAMPLES

### Example 1: Synthesis of Solid-State Electrolyte Using Ethanol

0.876 g Na₂S and elemental sulfur were added to a vial containing ethanol. The mixture was stirred and subsequently filtered to remove any undissolved materials. 1.143 g LiCl was added to a vial with ethanol and subsequently filtered to remove any undissolved materials. The two solutions were subsequently mixed and stirred for 2 hours at 25° C. forming NaCl and Li₂S. NaCl was removed by centrifuging the mixture and decanting the Li₂S solution. P₂S₅ was added to a vial containing pyridine. The P₂S₅/pyridine solution was added to the Li₂S solution to form a mixture comprising Li₂S/LiCl/ethanol/P₂S₅/pyridine. The mixture was heated to 140° C. under vacuum to remove ethanol and pyridine. The dried mixture was calcinated at 450° C. for 1 hour to remove any residual solvents and form a product mixture including Li₆PS₅Cl, Li₂S, and Li₃PO₄.

### Example 2: Synthesis of Solid-State Electrolyte Using Ethanol and Pyridine

0.876 g Na₂S and elemental sulfur were added to a vial containing ethanol. The mixture was stirred and subsequently filtered to remove any undissolved materials. 1.143 g LiCl was added to a vial with ethanol and subsequently filtered to remove any undissolved materials. The two solutions were subsequently mixed and stirred for 2 hours at 25° C. forming NaCl and Li₂S. NaCl was removed by centrifuging the mixture and decanting the Li₂S solution. P₂S₅ was added to a vial containing pyridine. The P₂S₅/pyridine solution was added to the Li₂S solution to form a mixture comprising Li₂S/LiCl/ethanol/P₂S₅/pyridine. The mixture was heated to 140° C. under vacuum to remove ethanol and pyridine. The dried mixture was calcinated at 450° C. for 1 hour to remove any residual solvents and form a product mixture including Li₆PS₅Cl, Li₂S, and Li₃PO₄.

### Example 3

The material of example 3 was produced in the same way as in example 2 except the amount of P₂S₅ used was increased by 7.5 wt %.

### Example 4

The material of example 4 was produced in the same way as in example 2 except the amount of P₂S₅ used was increased by 10 wt %.

### Example 5

The material of example 5 was produced in the same way as in example 2 except the amount of P₂S₅ used was increased by 15 wt %.

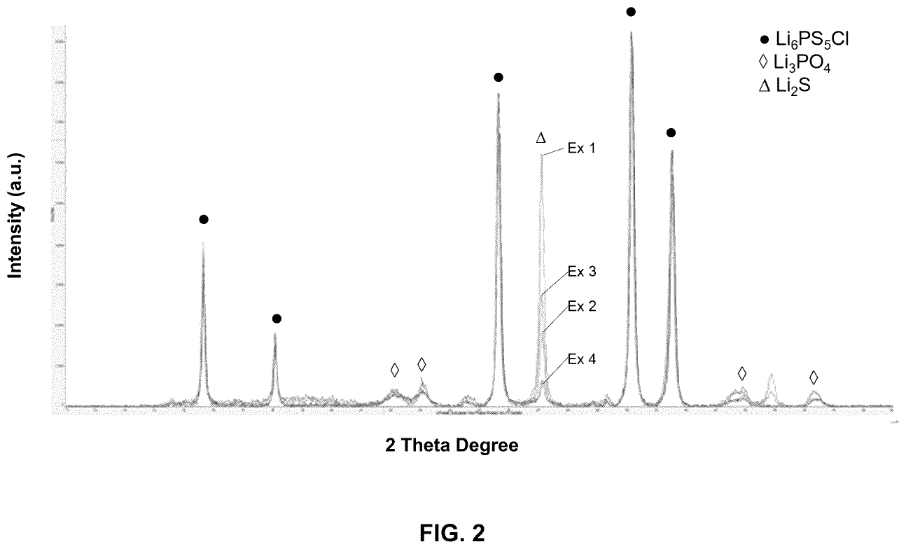

FIG. 2 shows X-ray diffraction pattern of the product mixtures obtained by varying the amount of pyridine and phosphorous sulfide used in the process as described by the process outlined in Examples 2, 4, and 5. The amount of Li₃PO₄ decreases with the addition of pyridine. When the ethanol:pyridine ratio is 1:0, the product mixture includes 8.7 wt % of Li₃PO₄. The amount of Li₃PO₄ decreases to 6 wt % with the addition of pyridine. Similarly, the amount of Li₂S in the product mixture decreased from 23 wt % to 8 wt % upon the addition of pyridine, which can be seen by comparing Example 1 to Example 2. A further decrease in the amount of Li₂S was seen after the addition of excess P₂S₅ to the intermediate mixture from 8 wt % to 3 wt %, which can be seen by comparing Example 2 to Example 4.

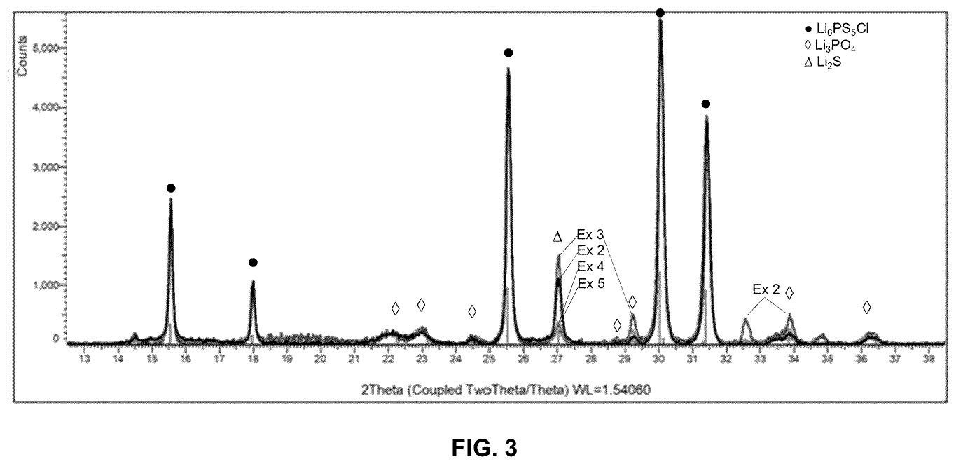

FIG. 3 shows the X-ray diffraction pattern of the product mixtures obtained by varying excess weight percent of P₂S₅ used in the process. The ratio of ethanol to pyridine was kept constant at 4:1. FIG. 2 shows that using excess of 10 wt % or more resulted in the lowest amount of Li₂S and Li₃PO₄ in the product mixture.

### Example 6

0.5157 g Li₂S, 0.1905 g LiCl, and 0.55 g P₂S₅ were added to a vial containing 20 mL of ethanol. The materials were mixed in ethanol for 15 minute. After the 15 minute reaction time, the ethanol was removed by heating the solution to a temperature of 100° C. under vacuum condition for 1 hour forming a dried composite. The dried composite was then heated to a temperature of 450° C. for 30 minutes forming the electrolyte material of example 6. The molar ratio of Li₂S to Phosphorus used in the solution was 5:1.

### Example 7

The material of example 7 was produced in the same manner as in example 6 except a combination of P₂S₅ and elemental sulfur was used in place of P₂S₅. The molar ratio of the combination of P₂S₅ and elemental sulfur was such as to generate a P₄S₁₄ compound. The molar ratio of Li₂S to Phosphorus used in the solution was 5:1.1.

### Example 8

The material of example 8 was produced in the same manner as in example 6 except P₂S₅ was replaced by a P₄S₁₄ material. The molar ratio of Li₂S to Phosphorus used in the solution was 5:1.1.

### Example 9

The material of example 9 was produced in the same manner as in example 7 except a P₄S₃ material was used in place of P₂S₅. The molar ratio of Li₂S to Phosphorus used in the solution was 5:1.1.

### Example 10

The material of example 10 was produced in the same manner as in example 7 except the molar ratio of a combination of P₂S₅ and elemental sulfur was such as to generate a P₄S₂₀ material in the solution. The molar ratio of Li₂S to Phosphorus used in the solution was 5:1.1.

### Example 11

The material of example 11 was produced in the same manner as in example 8 except the P₄S₁₄ material was replaced by a P₄S₂₀ material. The molar ratio of Li₂S to Phosphorus used in the solution was 5:1.1.

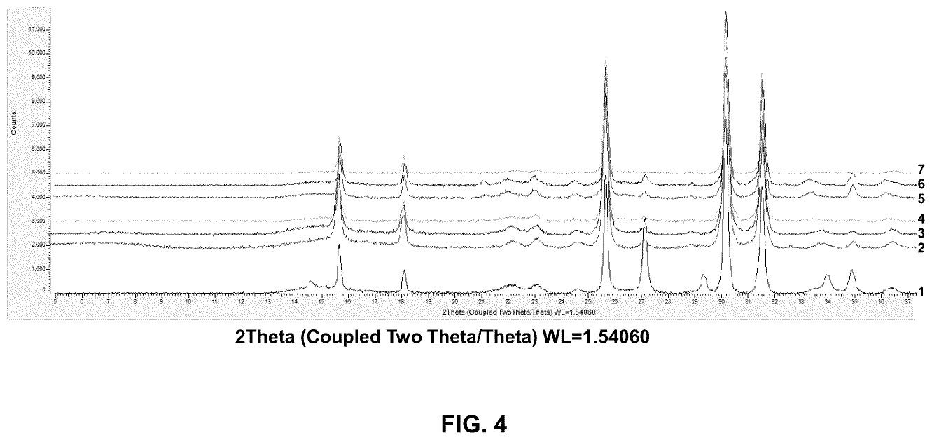

FIG. 4 shows the X-ray diffraction pattern of product mixtures obtained by using phosphorous sulfide only, a combination of phosphorous sulfide and elemental sulfur in different forms. 1 represents X-ray diffraction pattern of the product mixture when only P₂S₅ was used. 2 and 5 represent X-ray diffraction patterns of the product mixtures when P₂S₅ and sulfur in solution was used to form a P₄S₁₄ and P₄S₂₀ material respectively. 3 and 6 represent X-ray diffraction patterns of the product mixtures when P₄S₁₄ and P₄S₂₀ were added to the solution, where P₄S₁₄ and P₄S₂₀ were made by heating P₂S₅ and sulfur in their respective amounts, respectively. 4 and 7 represent X-ray diffraction patterns of the product mixtures when P₄S₃ and sulfur in solution was used to form a P₄S₁₄ and P₄S₂₀ material respectively.

### Example 12

The material of example 12 was produced in the same manner as in example 10 except the P₂S₅ was replaced by P₄S₃. The molar ratio of Li₂S to Phosphorus used in the solution was 5:1.1.

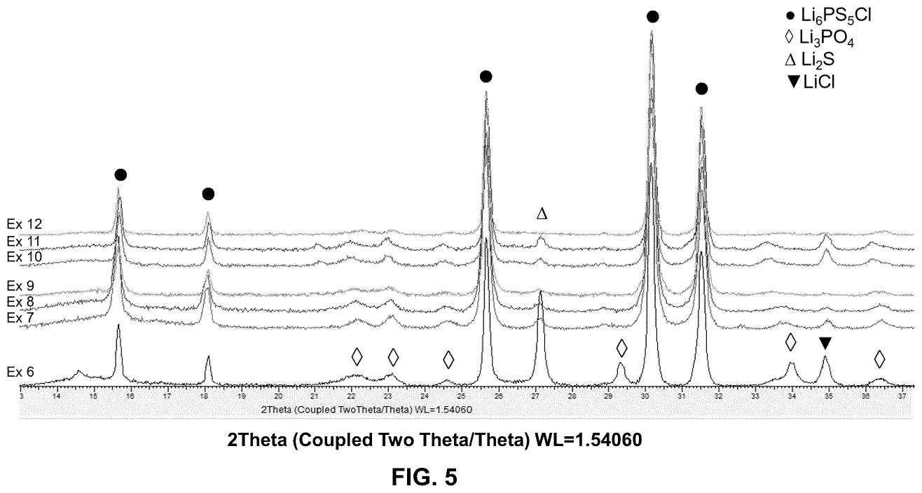

FIG. 5 shows the X-ray diffraction pattern of the product mixtures obtained by using different types of phosphorous sulfides and/or elemental sulfur.

Table 1 shows the ionic conductivity of the different products produced in Examples 6-12. In Example 6, P₂S₅ was used as the additional sulfur source resulting in the lowest ionic conductivity. In Example 7, Example 8, and Example 10, P₂S₅ and elemental sulfur were used as the one or more additional sulfur sources resulting in an ionic conductivity of the product of 1.25 mS, 1.32 mS, and 1.08 mS. When P₄S₁₄ was used as the additional sulfur source, the ionic conductivity of the product increased slightly to 1.32 mS. Surprisingly, when P₄S₃ was used as the additional sulfur source, the resulting product exhibited the highest ionic conductivity as illustrated by Example 9 and Example 12 of 1.62 mS and 1.94 mS.

| | P:S Molar Ratio of | P:S Molar Ratio | Phosphorous sulfur | Ionic Conductivity |
|---|---|---|---|---|
| Example | Starting Material | of Material | material in solution | (mS) |
| 6 | 0.4 | 0.4 | P₄S₁₀ | 0.199 |
| 7 | 0.4 | 0.286 | P₄S₁₄ | 1.25 |
| 8 | 0.286 | 0.286 | P₄S₁₄ | 1.32 |
| 9 | 1.33 | 0.286 | P₄S₁₄ | 1.62 |
| 10 | 0.4 | 0.2 | P₄S₂₀ | 1.08 |
| 11 | 0.2 | 0.2 | P₄S₂₀ | 0.95 |
| 12 | 1.333 | 0.2 | P₄S₂₀ | 1.94 |

### Example 13

0.876 g Na₂S and elemental sulfur were added to a vial containing ethanol. The mixture was stirred and subsequently filtered to remove any undissolved materials. 1.143 g LiCl was added to a vial with ethanol and subsequently filtered to remove any undissolved materials. The two solutions were subsequently mixed and stirred for 2 hours at 25° C. forming NaCl and Li₂S. NaCl was removed by centrifuging the mixture and decanting the Li₂S solution. P₄S₃ and sulfur were added to the Li₂S solution where the molar ratio of the combination of P₂S₅ and elemental sulfur was such as to generate a P₄S₁₄ compound. The then formed mixture comprised Li₂S/LiCl/ethanol/P₄S₁₄. The mixture was heated to 140° C. under vacuum to remove the ethanol. The dried mixture was calcinated at 450° C. for 1 hour to remove any residual solvents and form a product mixture including Li₆PS₅Cl, Li₂S, and Li₃PO₄. The ionic conductivity of the material produced in example 13 was 1.29 mS. A sample of this material was analyzed using Inductively Coupled Plasma (ICP) Spectroscopy. Sample 13 was found to contain 0.14 wt % sodium which comes from the residual NaCl that was not removed form the ethanol solution. The inclusion of 0.14% sodium makes for a solid electrolyte material with a nominal composition of Li_{5.98}Na_{0.01}PS_{4.99}Cl_{1.01}.

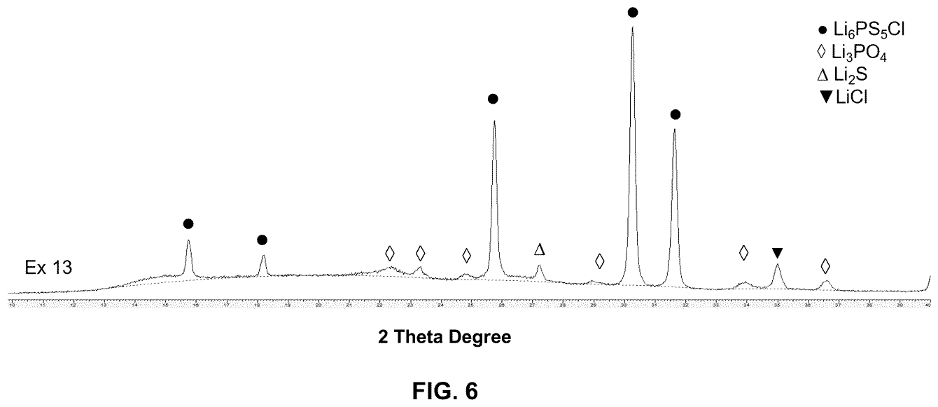

FIG. 6 shows the X-ray diffraction pattern of the product mixture obtained in Example 13.

Numerous examples are provided herein to enhance the understanding of the present disclosure. A specific set of statements are provided as follows.

Statement 1: A method of preparing Li_{(6-w)}PS_{(5-w)}X_{(1+w)}, the method comprising: combining LiX, Na₂S, and P₂S₅ in a solvent to form a mixture; and isolating a composition comprising Li_{(6-w)}PS_{(5-w)}X_{(1+w)} from the mixture; wherein w is between about −1 to about 1; and wherein X is one or more of Cl, Br, or I.

Statement 2: The method of statement 1, wherein the solvent comprises a polar organic solvent.

Statement 3: The method of statement 1, wherein the solvent comprises pyridine and a second solvent.

Statement 4: The method of statement 3, wherein the second solvent comprises an alcohol.

Statement 5: The method of statement 1, wherein the solvent comprises methanol, ethanol, pyridine, or a combination thereof.

Statement 6: The method of statement 1, wherein the isolated composition is at least 75% by weight Li_{(6-w)}PS_{(5-w)}X_{(1+w)}.

Statement 7: The method of statement 1, wherein the isolated composition is at least 85% by weight Li_{(6-w)}PS_{(5-w)}X_{(1+w)}.

Statement 8: The method of statement 1, wherein the isolated composition is at least 90% by weight Li_{(6-w)}PS_{(5-w)}X_{(1+w)}.

Statement 9: The method of statement 1, wherein the isolated composition is at least 95% by weight Li_{(6-w)}PS_{(5-w)}X_{(1+w)}.

Statement 10: The method of statement 1, wherein the isolated composition is at least 96% by weight Li_{(6-w)}PS_{(5-w)}X_{(1+w)}.

Statement 11: The method of statement 1, wherein the isolated composition is at least 97% by weight Li_{(6-w)}PS_{(5-w)}X_{(1+w)}.

Statement 12: A composition comprising at least 85% by weight Li₆PS₅X and between 0.01% and 15.0% Li₃PO_{4·}, wherein X is F, Cl, or Br.

Statement 13: The composition of statement 12, wherein the composition comprises least 90% by weight Li₆PS₅X and between 0.01% and 10.0% Li₃PO₄.

Statement 14: The composition of statement 12, wherein the composition comprises least 95% by weight Li₆PS₅X and between 0.01% and 5.0% Li₃PO₄.

Statement 15: The composition of statement 12, wherein the composition comprises between 0.01% and 1.5% Li₃PO₄.

Statement 16: The composition of statement 12, wherein the composition comprises between 0.01% and 1.5% by weight P₂S₅.

Statement 17: The composition of statement 12, wherein the composition comprises between 0.01% and 1.5% by weight Li₂S.

Statement 18: The composition of statement 12, wherein the composition comprises between 0.01% and 1.5% by weight Li₃PS₄, Li₇PS₆, Li₄PS₄I, Li_{5.5}PS_{4.5}ClBr_{0.5}, or a combination thereof.

Statement 19: The composition of statement 12, wherein the composition comprises between 0.01% and 1.5% by weight P₂S₅, between 0.01% by weight Li₂S, and between 0.01% and 1.5% by weight Li₃PS₄, Li₇PS₆, Li₄PS₄I, Li_{5.5}PS_{4.5}ClBr_{0.5}, or a combination thereof wherein X is F, Cl, or Br.

Statement 20: A method of preparing Li₃PO₄, the method comprising: combining LiX, Na₂S, and P₂S₅ in a solvent to form a mixture; and isolating a composition comprising Li₃PO₄ from the mixture; and wherein X is Cl, Br, or I.

Statement 21: The method of statement 20, wherein the solvent comprises a polar organic solvent.

Statement 22: The method of statement 20, wherein the solvent comprises pyridine and a second solvent.

Statement 23: The method of statement 22, wherein the second solvent comprises an alcohol.

Statement 24: The method of statement 20, wherein the solvent comprises ethanol, pyridine, or a combination thereof.

Statement 25: The method of statement 20, wherein the isolated composition is at least 50% by weight Li₃PO₄.

Statement 26: The method of statement 20, wherein the isolated composition is at least 60% by weight Li₃PO₄.

Statement 27: The method of statement 20, wherein the isolated composition is at least 75% by weight Li₃PO₄.

Statement 28: The method of statement 20, wherein the isolated composition is at least 85% by weight Li₃PO₄.

Statement 29: The method of statement 20, wherein the isolated composition is at least 90% by weight Li₃PO₄.

Statement 30: The method of statement 20, wherein the isolated composition is at least 95% by weight Li₃PO₄.

Statement 31: The method of statement 20, wherein the isolated composition is at least 96% by weight Li₃PO₄.

Statement 32: The method of statement 20, wherein the isolated composition is at least 97% by weight Li₃PO₄.

Statement 33: A method of preparing Li_{(6-w)}PS_{(5-w)}X_{(1+w)} or Li₃PO₄, the method comprising: combining LiX, Na₂S, and P₂S₅ in a solvent to form a mixture; and isolating a composition comprising Li_{(6-w)}PS_{(5-w)}X_{(1+w)}, Li₃PO₄, or a combination thereof from the mixture; wherein w is between about −1 to about 1; and wherein X is Cl, Br, or I.

Statement 34: A method of preparing Li₆PS₅Cl or Li₃PO₄, the method comprising: combining LiCl and Na₂S in a first solvent to form a mixture; isolating a Li₂S intermediate from the mixture; combining the Li₂S intermediate and P₂S₅ in a second solvent to form a second mixture; and isolating Li₆PS₅Cl, Li₃PO₄, or a combination thereof from the second mixture.

Statement 35: A method of producing lithium argyrodite or lithium phosphate, the method comprising (a) reacting a first metal sulfide, a first alkali metal salt, and elemental sulfur in a first polar solvent to produce a first intermediate mixture and a second alkali metal salt precipitate; wherein the first intermediate mixture comprises a second metal sulfide, the first polar solvent, and the first alkali metal salt; (b) separating the second alkali metal salt precipitate and the first intermediate mixture; (c) adding phosphorous sulfide to the first intermediate mixture comprising the first alkali metal salt, the second metal sulfide and the first polar solvent forming a second intermediate mixture, wherein the phosphorous sulfide comprises solid phosphorous sulfide, a solution of phosphorous sulfide in a second polar solvent, or a mixture thereof; (d) removing the first and the second polar solvent from the second intermediate mixture to produce a dried second intermediate mixture; and (e) calcining the dried second intermediate mixture to remove residual first and second polar solvents and to produce a product mixture comprising lithium argyrodite, lithium phosphate, or a combination thereof; wherein lithium phosphate comprises Li₃PO₄; and wherein the lithium argyrodite formula comprises Li_{(6-w)}PS_{(5-w)}X_{(1+w)}; wherein w is between about 1 to about 2; and wherein X is Cl, Br, or I.

Statement 36: The method of statement 35, wherein the first alkali metal salt, elemental sulfur, and the first metal sulfide are separately dissolved in aliquots of the first polar solvent, which separate aliquots are then combined to form the first intermediate mixture.

Statement 37: The method of statement 35, wherein the phosphorous sulfide solution comprises about 5 wt % to about 20 wt % of P₂S₅.

Statement 38: The method of statement 35, wherein amount of phosphorous sulfide added correlates with the amount of Li₃PO₄ formed.

Statement 39: The method of statement 35, wherein the removing the first and the second polar solvent comprises evaporating the first and second polar solvent to produce a powder.

Statement 40: The method of statement 39, wherein the evaporating comprises drying the powder to remove substantially all of the first and second polar solvent.

Statement 41: The method of statement 39, wherein over 99% by weight of the first and second polar solvent from the powder is removed.

Statement 42: The method of statement 39, wherein the removing the first and the second polar solvent comprises spray drying, rotary drying, tray drying, fluidized bed drying, vacuum drying, or a combination thereof.

Statement 43: The method of statement 35, wherein separating the second alkali metal salt from the first intermediate mixture comprises at least one of centrifuging, filtering, gravity settling, and cooling.

Statement 44: The method of statement 35, wherein the first metal sulfide comprises Na₂S, the first alkali metal salt comprises LiCl, the second metal sulfide comprises Li₂S, and the phosphorous sulfide comprises P₂S₅.

Statement 45: The method of statement 35, wherein the second alkali metal salt comprises NaCl and the second sulfide comprises Li₂S.

Statement 46: The method of statement 35, wherein the first polar solvent comprises at least one alcohol selected from the group consisting of ethanol, 1-propanol, 1-butanol, and mixtures thereof.

Statement 47: The method of statement 35, wherein the second polar solvent comprises pyridine, imidazole, and mixtures thereof.

Statement 48: The method of statement 35, wherein the second polar solvent is pyridine.

Statement 49: The method of statement 35, wherein removing the second alkali metal salt from the supernatant comprises at least one of centrifuging, filtering, gravity settling, and cooling.

Statement 50: The method of statement 35, wherein the first and second polar solvents are substantially anhydrous.

Statement 51: The method of statement 35, wherein the ratio of the solubility of the second sulfide to the solubility of the second alkali metal salt in the polar solvent is at least 90:10.

Statement 52: The method of statement 35, wherein the ratio of the solubility of the second sulfide to the solubility of the second alkali metal salt in the polar solvent is at least 97:3.

Statement 53: The method of statement 35, wherein the ratio of the solubility of the second sulfide to the solubility of the second alkali metal salt in the polar solvent is at least 99:1

Statement 54: The method of statement 35, wherein the ratio of the solubility of the second sulfide to the solubility of the second alkali metal salt in the polar solvent is at least 99.9:0.1.

Statement 55: The method of statement 35, wherein the first metal sulfide compound is selected from the group consisting of K₂S, Na₂S, (NH₄)₂S, and mixtures thereof.

Statement 56: The method of statement 35, wherein the second sulfide comprises Li₂S.

Statement 57: The method of statement 35, wherein the phosphorous sulfide is P₂S₅.

Statement 58: The method of statement 35, wherein the second sulfide comprises a purity of 95% or greater.

Statement 59: The method of statement 35, wherein the second sulfide has a mass loss of less than 10% when heated above 100° C.

Statement 60: The method of statement 35, wherein the second sulfide has a mass loss of less than 13% when heated above 340° C.

Statement 61: A solid-state electrolyte comprising the lithium argyrodite produced by the method of statement 1.

Features described above as well as those claimed below may be combined in various ways without departing from the scope hereof. It should thus be noted that the matter contained in the above description or shown in the accompanying drawings should be interpreted as illustrative and not in a limiting sense. The above-described embodiments should be considered as examples of the present invention, rather than as limiting the scope of the invention. In addition to the foregoing embodiments of inventions, review of the detailed description and accompanying drawings will show that there are other embodiments of such inventions. Accordingly, many combinations, permutations, variations and modifications of the foregoing embodiments of inventions not set forth explicitly herein will nevertheless fall within the scope of such inventions. The following claims are intended to cover generic and specific features described herein, as well as all statements of the scope of the present method and system, which, as a matter of language, might be said to fall there between.

What is claimed is:

1. A method of preparing a lithium argyrodite Li_{(6-w)}PS_{(5-w)}X_{(1+w)}, the method comprising:
combining LiX, Y₂S, and an additional one or more sulfur source in a solvent to form a mixture; and
isolating a composition comprising Li_{(6-w)}PS_{(5-w)}X_{(1+w)} from the mixture;
wherein w is between about −1 to about 1;
wherein X is one or more of Cl, Br, or I; and
wherein Y is Na or Li.

2. The method of claim 1, wherein the solvent comprises a polar organic solvent.

3. The method of claim 1, wherein the solvent comprises pyridine and a second solvent.

4. The method of claim 3, wherein the second solvent comprises an alcohol.

5. The method of claim 1, wherein the solvent comprises methanol, ethanol, pyridine, or a combination thereof.

6. The method of claim 1, wherein the additional one or more sulfur source comprises phosphorous sulfide, elemental sulfur, or a combination thereof.

7. The method of claim 6, wherein the phosphorous sulfides comprise P₄S₃, P₂S₅, P₄S₄, P₄S₅, P₄S₆, P₄S₇, P₄S₈, P₄S₉, P₄S₁₁, P₄S₁₂, P₄S₁₃, P₄S₁₄, P₄S₂₀, P₄S₃, or a combination thereof.

8. The method of claim 1, wherein w is 0, X is Cl, and Y is Na.

9. The method of claim 1, wherein w is 0, X is Cl, and Y is Li.

10. The method of claim 1, wherein the isolated composition is at least 85% by weight Li_{(6-w)}PS_{(5-w)}X_{(1+w)}.

11. The method of claim 1, wherein the isolated composition is at least 97% by weight Li_{(6-w)}PS_{(5-w)}X_{(1+w)}.

12. A composition comprising at least 85% by weight Li₆PS₅X and between 0.01% and 15.0% Li₃PO_{4·}, wherein X is F, Cl, or Br.

13. The composition of claim 12, wherein the composition comprises least 95% by weight Li₆PS₅X and between 0.01% and 5.0% Li₃PO₄.

14. The composition of claim 12, wherein the composition comprises between 0.01% and 1.5% by weight Li₃PO₄.

15. The composition of claim 12, wherein the composition comprises between 0.01% and 1.5% by weight P₂S₅ or P₃S₄.

16. The composition of claim 12, wherein the composition comprises between 0.01% and 1.5% by weight Li₂S.

17. The composition of claim 12, wherein the composition comprises between 0.01% and 1.5% by weight Li₃PS₄, Li₇PS₆, Li₄PS₄I, Li_{5.5}PS_{4.5}ClBr_{0.5}, or a combination thereof.

18. The composition of claim 12, wherein the composition comprises between 0.01% and 1.5% by weight P₂S₅, between 0.01% by weight Li₂S, and between 0.01% and 1.5% by weight Li₃PS₄, Li₇PS₆, Li₄PS₄I, Li_{5.5}PS_{4.5}ClBr_{0.5}, or a combination thereof wherein X is F, Cl, or Br.

19. A method of preparing Li_{(6-w)}PS_{(5-w)}X_{(1+w)} or Li₃PO₄, the method comprising:
combining LiX, Y₂S, and an additional one or more sulfur source in a solvent to form a mixture; and
isolating a composition comprising Li_{(6-w)}PS_{(5-w)}X_{(1+w)} from the mixture;
wherein w is between about −1 to about 1;
wherein X is one or more of Cl, Br, or I; and
wherein Y is Na or Li.

20. The method of claim 19, wherein the solvent comprises pyridine and a second solvent.

21. The method of claim 20, wherein the second solvent comprises an alcohol, and wherein the alcohol comprises methanol or ethanol.

22. The method of claim 19, wherein the additional one or more sulfur source comprises phosphorous sulfide, elemental sulfur, or a combination thereof, and wherein the phosphorous sulfides comprise P₂S₅, P₄S₁₄, P₄S₂₀, P₄S₃, or a combination thereof.

23. A solid-state electrolyte comprising the lithium argyrodite produced by the method of claim 1.
